(19) United States
(12) Patent Application Publication
(10) Pub. No.: US 2002/0059512 A1
(43) Pub. Date: May 16, 2002

(54) Method and system for managing an information technology project

(76) Inventor: Lisa Desjardins, Richmond, VA (US)

Correspondence Address: Jennifer A. Albert, Esq., Hunton & Williams, 1900 K. Street, N.W., Suite 1200, Washington, DC, 20006, US

(21) Appl. No.: 09/977,284

(22) Filed: Oct. 16, 2001

Related U.S. Application Data
(60) Provisional application No. 60/240,070, filed on Oct. 16, 2000.

(51) Int. Cl. G06F 9/00

(52) U.S. Cl. 713/1

(57) ABSTRACT

A structured process for developing a project for managing an information technology project includes a series of principal steps, each of which includes one or more substeps. The principal steps may include: (1) assessing the feasibility of the project to determine whether to proceed with the project; (2) performing initial project analysis to determine the project's functional requirements; (3) designing the IT product; (4) building the IT product; (5) testing the IT product; (6) implementing the IT product; and (7) closing-out the IT project, including evaluating the project. A method is also provided for providing, accessing and using the structured process. The method can be implemented using computer technology by storing the information regarding the structured process in a database and using a computer (or network of computers) to access and utilize the information. The computer may include an output device for presenting information regarding the status of the structured process, including an indication of the level of completion of each principal step.

This application claims the benefit of U.S. Provisional Application No. 60/240,070, filed on Oct. 16, 2000.

### BACKGROUND OF THE INVENTION

The present invention relates to a method and system for managing an information technology (IT) project. In particular, the present invention relates to a method and system for managing an IT project using a structured technique including multiple steps.

The rapid pace of technological advancement requires an organization to periodically update its information technology resources. Information technology (commonly known as IT) generally pertains to systems, equipment and/or software used to store, retrieve, transfer, process and/or render data. For instance, an organization's IT resources may include network systems and services (e.g., intranet, Internet, etc.), database management systems and services, e-commerce systems and services, administrative systems and services (e.g., accounting systems and services), etc.

Many organizations approach the task of developing an IT product in an ad hoc manner. This approach typically entails quickly making a change to a system, observing the impact of the change, and then taking any necessary corrective action. Depending on the magnitude of the project, some organizations may attempt to plan out the IT project by defining different phases of the project, identifying budgetary constraints, and formulating a timeline for completing different phases of the project.

Not surprisingly, informal approaches to IT projects may run into difficulties. For instance, an unstructured approach to IT projects may result in the inefficient (e.g., non-optimal) sequencing of tasks in the project. An unstructured approach may further result in inadequate communication of instructions to project participants. Further, an unstructured approach may result in the failure to obtain necessary approval from the appropriate business and technology sectors within the organization. These factors may lead to increased costs in developing the IT product, delays in delivering the IT product, and/or substandard quality of the IT product itself. In extreme cases, the unstructured approach may lead to the ultimate failure of the project.

Further still, an unstructured approach provides no mechanism for identifying why a project has succeeded or failed. Accordingly, future projects may fail to incorporate project features that have been beneficial in previous projects. On the other hand, future projects may unknowingly repeat project features that have caused problems in previous projects.

As described above, some organizations have attempted to “manage” IT projects by creating project plans. Nevertheless, such plans are commonly developed from “scratch” for each IT project based on the unique requirements of each IT project. Accordingly, these application-specific plans do not readily lend themselves to adaptation to other projects. This further results in the inefficient use of human resources in the delivery of IT products, as the work product of earlier projects cannot readily be applied to new projects.

The patent and technical literature does not adequately address the above problems. A number of patents are directed to providing computerized tools to assist a user in project management. For instance, U.S. Pat. No. 6,036,345 describes a design and engineering project management system. The system includes logic for identifying overall product objectives and group objectives relating to subsystems or components of an overall product. The computer further includes logic for displaying the overall objective and group objectives in a plurality of graphic windows which can be retrieved by a user. The system also includes logic for identifying one or more strategies for achieving group objectives, and for presenting the strategies in a graphic form which allows for quick comparison of competing strategies. The system also includes logic for quantitatively measuring progress toward each group's stated objectives and providing a plurality of graphic displays indicating each group's, and the entire project's, progress toward its objectives.

The above-described patent therefore provides tools for coordinating and monitoring the activities of multiple groups involved in a project. However, the patent does not disclose any type of structured template for managing an IT project. Accordingly, the patent does not identify how to rectify the particular problems noted above.

There is therefore a need to provide a more efficient technique for the management of IT projects.

### BRIEF SUMMARY OF THE INVENTION

A structured process for managing an information technology (IT) project to produce an information technology (IT) product includes a series of principal steps, each of which includes one or more substeps. The principal steps may include: (1) assessing the feasibility of the project to determine whether to proceed with the project; (2) performing initial project analysis to determine the project's functional requirements; (3) designing the IT product; (4) building the IT product; (5) testing the IT product; (6) implementing the IT product; and (7) closing-out the IT project, including evaluating the project.

In order to advance to a next successive step, the project participants must seek approval of one or more authorizing agents.

A method is also provided for providing, accessing and using the structured process. The method includes providing information regarding the structured process, including: (1) first data regarding principal steps of the structured process; (2) second data regarding substeps included in each principal step; and (3) third data regarding approval procedures performed during the process for validating the viability of the project. The method then includes a step of accessing the information and performing the principal steps, substeps, and approval procedures specified in the accessed information. This method can be implemented, for example, using computer technology by storing the information regarding the structured process in a database and using a computer (or network of computers) to access and utilize the information.

The computer may include an output device (e.g., a display or printer) for presenting information regarding the status of the structured process, including an indication of the level of completion of each principal step.

### BRIEF DESCRIPTION OF THE DRAWINGS

The present invention can be understood more completely by reading the following Detailed Description of exemplary embodiments, in conjunction with the accompanying drawings, in which:

FIGS. 1A, 1B and 1C together describe a structured process for managing an IT project;

FIG. 2 shows an exemplary system for implementing the process shown in FIGS. 1A, 1B and 1C;

FIG. 3 describes an exemplary database for storing information used in the process shown in FIGS. 1A, 1B and 1C;

FIG. 4 shows an exemplary main screen page for presenting information pertaining to principal steps in the process;

FIG. 5 shows an exemplary screen page for presenting information pertaining to one of the principal steps listed in FIG. 4; and

FIG. 6 shows a “thermometer” display screen for presenting an overview of the level of completion of the process.

### DETAILED DESCRIPTION OF THE INVENTION

1. The Project Management Technique

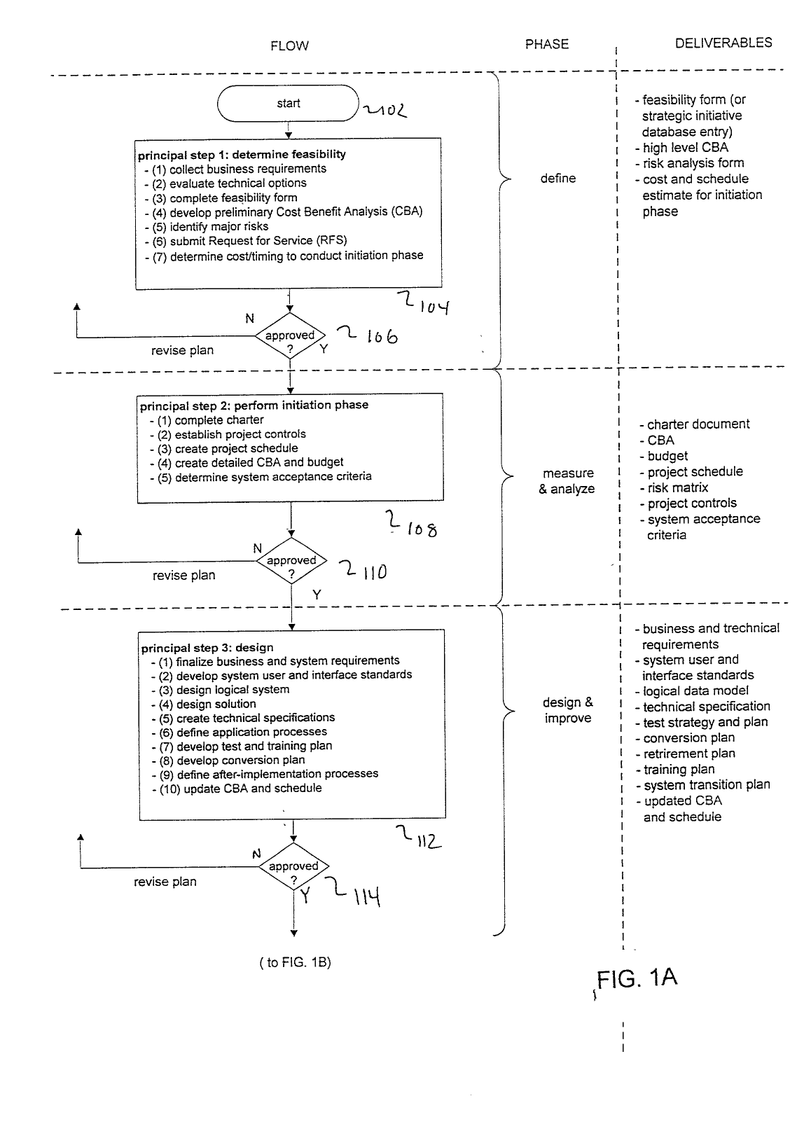

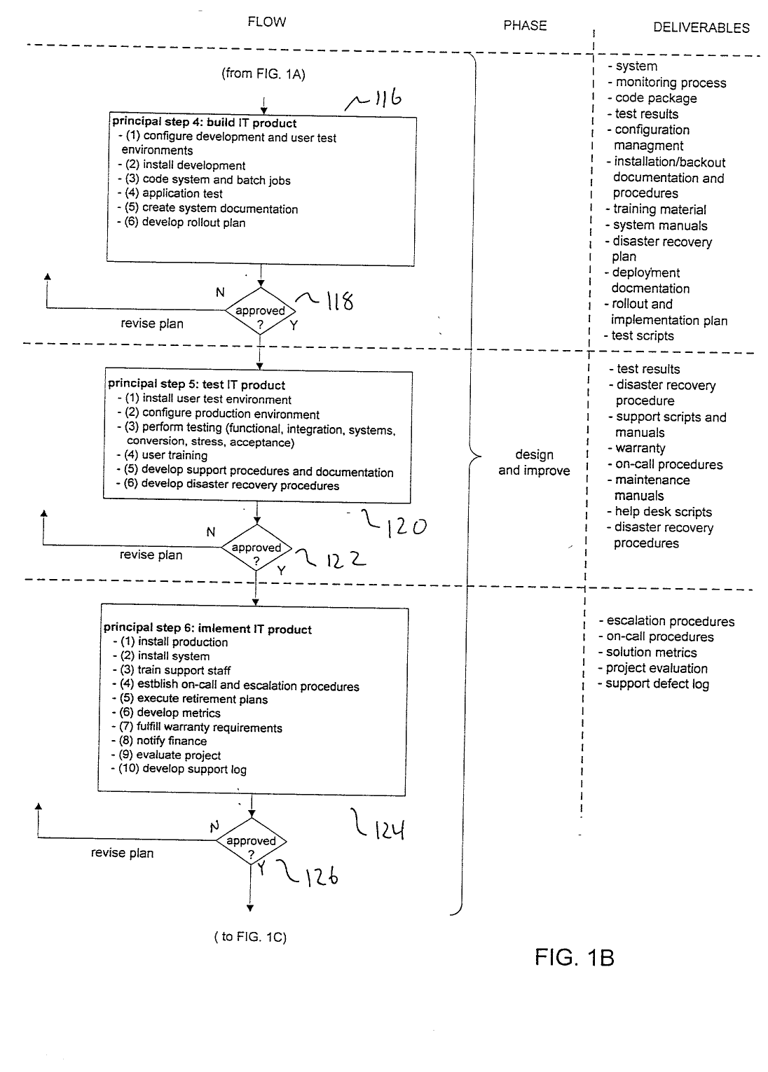

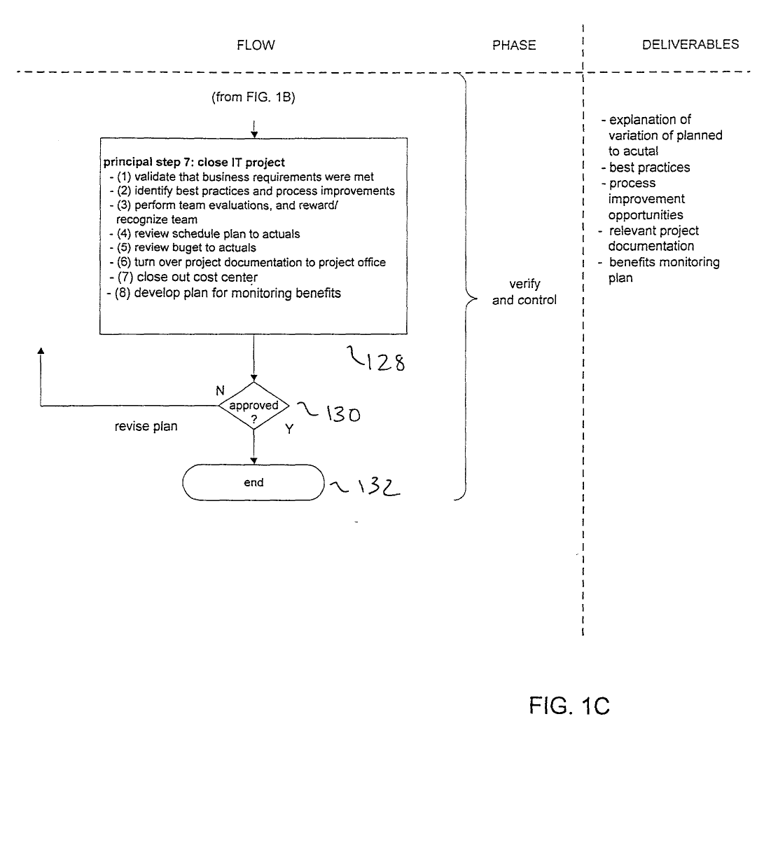

FIG. 1 (including FIGS. 1A, 1B and 1C) identifies exemplary steps in a process for managing an information technology project. The information technology project may pertain to a wide range of projects, including the introduction or upgrade of various local network systems or services (e.g., intranet applications), various database management systems or services, various Internet systems or services (e.g., web page applications), various administrative systems and services (e.g., accounting systems and services), etc. To simplify the explanation, the ensuing discussion generically refers to any system or service produced by the IT project as an “IT product,” or alternatively, an “IT solution.”

The principles described here can be used to supply IT solutions to any entity, including any person or organization (such as a partnership, corporation, non-profit organization, government organization, etc.). For instance, the techniques can be used by a project management team within an organization to develop IT products for use by the organization. The techniques can also be used by a project management team to supply IT solutions to any other individual or organization (e.g., on a contract basis). To simplify the explanation, the ensuing discussion assumes that a project management team is acting within an organizational setting and is using the technique to supply an IT solution to its own organization, or some other organization.

By way of overview, one basic purpose of the management technique is to provide rigor to the IT development process. At the same time, another purpose of the technique is to provide a structured process that is flexible enough to serve a variety of different IT applications (such as, but not limited to, the applications mentioned above).

Turning now to FIG. 1, the process generally includes seven principal steps interspersed with approval steps. The principal steps pertain to basic tasks performed in developing an IT project. The first principal step 104 pertains to the task of assessing the feasibility of the project to determine whether to proceed with the project. The second principal step 108 pertains to performing initial project analysis to determine the project's functional requirements. The third principal step 112 pertains to designing the IT product. The fourth principal step 116 pertains to building the IT product. The fifth principal step 120 pertains to testing the IT product. The sixth principal step 124 pertains to implementing the IT product. The last principal step 128 pertains to closing-out the IT project, which includes evaluating the project.

On a higher level of abstraction, the process flow can be categorized into multiple phases. The correspondence between the phases and the principal steps may not be exact. Nevertheless, a Definition Phase generally corresponds to the first principal step (i.e., assessing the feasibility of the project). A Measurement and Analysis Phase generally corresponds to the second principal step (i.e., performing initial project analysis). A Design and Improvement phase generally corresponds to the third, fourth, fifth and sixth principal steps (i.e., designing, building, testing and implementing the IT product). Finally, a Verify and Control Phase generally corresponds to the seventh principal step (i.e., closing-out the IT project). These phases are identified in the vertical column adjacent to the flow steps. The phases (Define, Measurement, Analysis, Improvement, Verify and Control) collectively represent a structured and “scientific” approach to developing the IT project.

Each principal step may produce one or more outputs, referred to as “deliverables.” The deliverables may comprise documents or related products (e.g., systems, software code, etc.) generated in the course of performing the principal step. The right-most column in FIG. 1 identifies the deliverables produced by each principal step. These deliverables are also discussed in further detail below.

Selected principal steps terminate in approval steps, which define an approval procedure. For instance, the first principal step 104 terminates in approval procedure 106. The second principal step 108 terminates in approval step 110. The third principal step 112 terminates in approval step 114. The fourth principal step 116 terminates in approval step 118. The fifth principal step 120 terminates in approval step 122. The sixth principal step 124 terminates in approval step 126. And the seventh principal step 128 terminates in approval step 130. Approval procedures establish baseline criteria that the evolving project should meet, at various stages of development, to ensure that it remains viable. For instance, approval step 106 defines criteria that the project should meet at the completion of the first principal step 104. The approval procedures also identify the individuals (referred to herein as “authorizing agents”) assigned the role of evaluating the developing project with reference to the baseline criteria.

The authorizing agents used to approve a principal step may vary depending on the business environment in which the IT solution is presented, as well as the characteristics of the IT solution itself. For instance, an IT solution pertaining to a telecommunications system would likely use a different set of authorizing agents than an IT solution pertaining to an accounts receivable program. That is, a project pertaining to a telecommunications system may warrant the use of agents having familiarity with telecommunications infrastructure, routers, etc. In contrast, a project pertaining to an accounts receivable system may warrant the use of agents having experience with programming, business operations, accounting principles, etc.

The effect of the approval steps is to halt the development of the project at various stages of the process and demand that the process satisfy prescribed criteria. In this sense, the approval steps serve as gates or checkpoints. A developing project that fails to satisfy the prescribed criteria will not advance to the next stage of development (e.g., it will not advance to the next principal step). If this is the case, the project developers have two choices. They may attempt to revise the project by repeating one or more subtasks in one or more previous principal steps. This is indicated by the instruction “revise plan” in FIG. 1. Alternatively, the developers may be forced to abandon the project. This may be appropriate, for example, if it is discovered that the project requires resources that cannot be obtained or the project has an irreconcilable conflict with another project or other business program.

FIG. 1 indicates that each of the principal steps includes one or more substeps. The substeps describe subtasks pertaining to the basic task defined by the principal step. The subtasks generally provide a structure and rigor in performing the principal tasks. Specific substeps are described below for each principal step. However, it should be noted that some IT projects may apply only a subset of the substeps identified below. Other IT projects my add additional substeps to suit particular IT applications. Further, in one embodiment, the substeps may be executed in any order (e.g., not necessarily in the order described below).

Having described the process for managing an information technology project in general terms, it is now possible to discuss the individual principal steps, substeps, approval steps, and deliverables in greater detail.

A. First Principal Step

The purpose of the first principal step (assess feasibility) is to make an initial high-level assessment of whether a particular IT project is worth pursuing. By way of overview, this may involve: (1) assessing the benefits that the IT solution may provide to the organization; (2) determining whether the organization can effectively implement the IT solution; and (3) determining whether, once implemented, the organization can support the IT solution. The first principal step serves a useful function because project management personnel may have numerous demands for new or updated IT products, but limited resources. Another purpose of the first principal step is to ensure that sufficient information has been collected for subsequent phases of the project

The party responsible for performing the first principal step may comprise an appropriate strategy and/or business project leader. A strategy leader typically works within an IT group to identify the IT resources necessary to satisfy business objectives. A business project leader typically works outside of an IT group to attend to the needs of the business on a more general level. The first principal step may receive inputs (e.g., information and/or other deliverables) from one or more of the following individuals or groups: (1) any appropriate personnel from various IT technology sectors; (2) any appropriate business personnel; (3) vendors; (4) benchmarking entities, etc. Benchmarking entities refer to entities (either inside or outside the organization) that have familiarity with the types of issues presented by the current project. These entities thus provide an exemplary baseline against which the viability of the current project may be gauged.

The first principal step may specifically include seven substeps. The first (1) substep entails identifying (i.e., collecting) the business requirements associated with the IT solution. This step may involve making a high-level assessment of the problems faced by a particular business area within an organization and the resources necessary to remedy these problems.

The second (2) substep involves evaluating technical options. This substep may entail defining alternatives to the designated IT solution and examining the business-related and technical impact of each alternative (e.g., defining what areas of the business and technical infrastructure will be affected, and the extent to which they will be affected).

The third (3) substep involves completing a “feasibility form.” The feasibility form comprises a checksheet which prompts the responsible party to examine and document various aspects of the project's feasibility. For example, in one exemplary case, the feasibility form may prompt the responsible party to: (a) identify how the project fits in with other IT projects initiated by the organization; (b) identify how the project fits in with the general business plans or initiatives of the organization; (c) identify the benefits that the project is projected to provide; (d) identify the level of service that the IT solution should satisfy based on the expectations and demands of the entity receiving the benefits of the solution, e.g., as reflected in high-level “Service Level Agreements” (i.e., SLAs) (e) identify the aspects or elements of the project which are regarded as particularly critical to the quality of the IT product (e.g., Critical To Quality factors, or CTQs); (f) identify the timeframes for performing the tasks of the project; (g) identify major deliverables of the project (e.g., the systems and/or services generated by the project); (h) identify the scope of the project (e.g., identify the metes and bounds of the project's objectives, as well as identify the parts and functions of the business that will be affected by the project and the considerations raised thereby); (i) identify those individuals (referred to as “business champions”) who have a strong interest in the success of the project, such as those individuals who typically support the project on a senior leadership level and serve as representatives of the project within the organization; (j) identify those individuals (referred to as “process owners”) who are instrumental in carrying out processes that are involved in the project or may be impacted by the project; (k) review the project strategy (e.g., review the strategy to determine what basic architecture and/or processes are envisioned); and (1) identify whether the IT solution has been implemented by the organization in the past, and if so, examine the incidents of the implementation.

The fourth (4) substep involves developing a preliminary cost-benefit analysis in order to define (by order of magnitude) the costs involved in the project.

The fifth (5) substep involves identifying the major risks posed by the project, as well as mitigating factors to these risks.

The sixth (6) substep involves submitting a request for service (RFS). In one exemplary organizational environment, an RFS may comprise a formal request for resources required to perform one or more tasks in the project.

Finally, the seventh (7) substep entails determining the schedule, required resources, team commitments, and costs involved in performing the second principal step, i.e., project initiation.

The output of the first principal step includes one or more of the following deliverables: (1) the feasibility form (defined above); (2) a high level cost-benefit analysis (e.g., having a specified confidence level, such as 70%); (3) a risk analysis form (which itemizes the identified risks of the project); and (4) a cost and schedule estimate for the second principal phase, i.e., the initiation phase.

The first principal step terminates in approval step 106. This step assesses the viability of the project mainly based on the analysis performed in the first principal step. Approval step 106 may employ a two-tier review process. In the first tier, appropriate authorizing agents perform a detailed audit of the deliverables to assess the technical viability of the project. Appropriate agents for this review may comprise one or more of: (a) IT subject matter experts; (b) business-related subject matter experts; (c) personnel which oversee the delivery of the IT solution (e.g., a “system deliver leader” ); and (d) project management subject matter experts. In the second tier review, appropriate authorizing agents review the project for financial viability (e.g., to determine whether proper resources can be allocated to the project). More specifically, an organization may choose to set up multiple levels of financial review depending on the projected cost of the project. In one exemplary organizational setting, an appropriate business leader may act as the authorizing agent if the cost is under a prescribed threshold level, e.g., $300,000. A CIO (Chief Information Officer) of the organization and other business personnel may act as the authorizing agents if the cost is above the prescribed threshold, e.g., $300,000 or greater.

If the authorizing agents approve the project, the process proceeds to the next principal step. If the authorizing agents do not approve the project, then the responsible parties may revise or abandon the project.

B. Second Principal Step

The purpose of the second principal step (i.e., initiate project) is to develop a detailed plan for carrying out the project, generate a more detailed cost benefit analysis, define a more detailed budget for the project, and identify appropriate controls for project execution. A further purpose of the second principal step is to ensure that all appropriate areas of IT were given input into the project. A further purpose of the second principal step is to ensure that the project management group has agreed to appropriate approval procedures for remaining checkpoints (i.e., approval steps), and that the approval procedures have been documented and disseminated to the necessary entities in the organization. A further purpose of the second principal step is to ensure that proper planning has taken place for the project.

The party responsible for performing the second principal step may comprise an appropriate IT project manager, and/or business project manager. The second principal step may receive inputs (e.g., information) from one or more of the following individuals or groups: (1) strategy and planning entities (including information gleaned from the feasibility form and high-level cost-benefit analysis produced in the first principal step); (2) any appropriate area of IT (e.g., any appropriate subject matter IT experts); (3) any appropriate area of business (e.g., any appropriate business-related subject matter experts); (4) vendors; and (5) any benchmarking entities.

The first (1) substep involves completing a project charter. A project charter defines basic features of the project. More specifically, in one exemplary business setting, a project charter may: (a) identify the organization of the project (where “organization” here pertains to the assigned roles and responsibilities of the project, the deliverables generated by the project, and the estimated resources that the project will consume, e.g., in terms of work effort and time expenditure); (b) finalize the risk analysis, which may include documenting constraints and assumptions involved in the project (c) finalize the goals, objectives and scope of the project; (d) define the approach used by the project; (e) define the testing strategy of the project; (f) document requirements and major deliverables of the project; (g) document assumptions and constraints of the project; and (h) identify training requirements of the project.

The second (2) substep entails defining project controls used in executing the project. Project controls pertain to guidelines used to manage various aspects of the project. For instance, in one exemplary business setting, the project controls may pertain to management of one or more of: (a) project scope (e.g., defining how to respond to changes in the scope of the project, such as when new functionality is added to the system); (b) issues that may arise in the course of the project; (c) project progress; (d) risks posed by the project (e.g., defining how to identify and monitor risks posed by the project, and how to monitor the effectiveness of mitigation and contingency plans); (e) communication issues posed by the project (e.g., defining how to maintain effective communications with sponsors, team members, customers, users, etc.); (f) costs (e.g., generally, budget-related issues); (g) problems that may arise; (h) error detection used in the project; (i) configuration issues presented by the project; (j) compliance issues raised by the project (e.g., issues raised with respect to the IT product's compliance with various technical and legal requirements); (k) contractual issues pertaining to the development of the project; and (1) the quality of deliverables. The project charter, discussed above, also preferably documents the project controls.

The third (3) substep entails providing a revised project schedule based on information obtained in the second principal step. The project schedule generated here is more detailed than the estimates made in the first principal step.

The fourth (4) substep entails creating a more detailed cost-benefit analysis and budget (compared to the first principal step). This substep may, in turn, entail: (a) determining resources and vendors for use in the project; (b) quantifying detailed costs and benefits for the project; and (c) outlining capitalization and cost allocation plans for the project.

The fifth (5) substep involves determining system acceptance criteria. System acceptance criteria define benchmark parameters used to determine whether the project is meeting its defined objectives.

The output of the second principal step includes one or more of the following deliverables: (1) the charter document; (2) a detailed cost-benefit analysis; (3) a project schedule; (4) risk analysis matrix (that identifies the risks of the project in a structured manner); (5) project controls documentation; (6) budget-related documentation (e.g., identifying the allocation and capitalization plan of the project); (7) system acceptance criteria; and (8) detailed requirements documentation.

The second principal step terminates in approval step 110. This step assesses the viability of the project mainly based on the analysis performed in the second principal step. This step may employ a two-tier review, like approval step 106. In the first tier, appropriate authorizing agents may perform a detailed audit of the quality of the deliverables. Appropriate authorized agents may include appropriate subject matter experts, supervisory project personnel (e.g., project management personnel), change management personnel (comprising supervisory individuals who ensure that code changes are properly documented and adequately supported), and security personnel (such as a security officer who ensures that project initiatives do not compromise confidential data maintained by the organization or its clients, etc.). In the second tier, appropriate authorizing agents may perform a review of the project to assess its financial viability. Cost-related review may be automatic, or may be performed only if there is a significant variation between the cost estimates made in the first principal step and the cost estimates made in the current step. Further, like approval step 106, different finance-related authorizing agents may be used depending on the projected cost of the project.

If the authorizing agents approve the project, the process proceeds to the next principal step. If the authorizing agents do not approve the project, then the developers may revise or abandon the project.

C. Third Principal Step

The purpose of the third principal step is to develop the detailed design of the solution (that is, to convert the functional requirements generated by the previous steps into technical requirements). Another purpose of this principal step is to ensure that proper design methods are utilized, to detect and eliminate design flaws, and to ensure acceptance of the solution by providing servicing (that is, by providing appropriate support for IT solution development).

The party responsible for performing the third principal step may comprise an appropriate IT project manager. The third principal step may receive inputs (e.g., information) from any appropriate IT or business-related subject matter expert.

The third principal step may specifically include seven substeps. The first (1) substep involves finalizing business and system requirements. For large projects, this substep may entail refining the projects plans. For smaller projects, this substep may simply involve revalidating the project plans (e.g., providing a second review of the project plans).

The second (2) substep involves developing various standards, such as development, user and system interface standards. For instance, a development standard may pertain to naming conventions used in the coding of the IT product. A user interface standard may pertain to conventions used to govern the visual layout and functionality of the IT product's user interface. System standards may pertain to conventions used to govern the interaction between the IT product and other products and systems.

The third (3) substep involves designing the logical system. This step entails establishing protocols defining the logical functionality of the IT solution. The logical functionality of the IT solution defines the operations performed by various modules and submodules used in the IT solution.

The fourth (4) substep involves designing the solution. The fourth substep may specifically entail defining business rules and logic that will govern the IT solution. The fourth substep also may involve defining data-related features of the product, such as the data model, data sources, data interfaces, data transactions, data conversion and data dictionary used by the product. (A data dictionary identifies the data fields used in an application.) The fourth substep may also entail defining the system architecture of the IT product. Additionally, the fourth substep may involve defining external system changes required by the IT solution (e.g., pertaining to changes in other interconnected systems that need to be made to accommodate the IT solution). The fourth substep may also involve designing various system functions and modules. The fourth substep may further entail defining a general installation strategy. A component of the general installation strategy is the “desktop strategy.” This refers to the strategy used to modify the users' equipment (e.g., personal computers) so that the equipment will be compatible with the IT solution. In extreme cases, this strategy may dictate that the users are supplied with new equipment (e.g., having faster processors).

The fifth (5) substep involves creating the technical specifications for the project.

The sixth (6) substep involves defining the application processes. This step may include: (a) defining the application processes (e.g., the functional processes of the IT solution); (b) defining the data flow used in the IT solution; (c) identifying application users that are affected by the IT solution; and (d) defining supporting programs and scheduling needs.

The seventh (7) substep involves developing a testing and training plan. The testing component of this substep may involve: (a) developing test plans and scripts; (b) identifying the testing teams; and (c) establishing a commitment from the testing teams. The training component of this step involves: (a) identifying users and their locations; (b) identifying the type of training that will be provided to the users; (c) defining training materials; and (d) defining training delivery strategies.

The eighth (8) substep involves developing a conversion plan. The conversion plan defines a strategy for transitioning from a prior system to the IT solution.

The ninth (9) substep involves defining “after-implementation” processes. These processes define actions taken subsequent to the implementation phase (i.e., the sixth principal step) to ensure the stability of the IT solution.

The tenth (10) substep involves updating the cost-benefit analysis and project schedule based on additional information that has been obtained since previous cost-benefit analyses.

Other processes (not listed in FIG. 1) may include creating an application retirement plan. This plan defines a strategy for retiring a system or service previously used by the organization. An exemplary task in a retirement strategy may consist of ensuring that the data maintained by the “old” system is transferred to the “new” system, or at least maintained in such a state that it can be accessed by the new system. Another task in the retirement strategy may consist of ensuring that licensing issues have been resolved so that the organization will not be charged for systems and software it no longer uses.

Another substep not identified in FIG. 1 may consist of defining help desk processes (e.g., processes used by support personnel to assist users in their use of the IT product). Another substep not identified in FIG. 1 may consist of developing an organization “change strategy.” This change strategy refers to a plan for installing the IT product's code (which involves ensuring that the correct version of the code is installed).

The output of the third principal step includes one or more of the following deliverables: (1) business and technical requirements; (2) system user and interface standards; (3) data model; (4) logical data model; (5) technical specification; (6) test strategy plan and scripts; (7) conversion plan; (8) retirement plan; (9) detailed training plan; (10) system transition plan; (11) updated cost benefit analysis and project schedule; and (12) IT product prototype (if applicable).

The third principal step terminates in approval step 114. This step assesses the viability of the project mainly based on the analysis performed in the third principal step. Exemplary authorizing agent(s) for the first principal step include one or more of: (1) technical and business subject matter experts; (2) servicing personnel; (3) developers; (4) database and infrastructure personnel; and (5) any personnel in the organization assigned the role of overseeing changes in the code (e.g., “change management personnel”). If the authorizing agents approve the project, the process proceeds to the next principal step. If the authorizing agents do not approve the project, then the developers may revise or abandon the project.

D. Fourth Principal Step

The foremost purpose of the fourth principal step is to provide a stable and tested IT solution. Other purposes of the fourth principal step are to: (1) ensure that proper coding standards are utilized; (2) detect and eliminate errors in the IT system/service; and (3) ensure acceptance of the IT product by providing adequate servicing of the IT product.

The responsible party for performing the fourth principal step may comprise an appropriate project manager. The second principal step may receive inputs (e.g., information) from any appropriate area of IT (e.g., any appropriate IT subject matter experts).

The fourth principal step may specifically include six substeps. The first (1) substep involves configuring development and user test environments. Configuring a development environment pertains to setting up the equipment, software, tools, passwords, protocols, etc. that may be required to proceed with the development of the IT solution. Similarly, configuring a test environment refers to setting up the equipment, tools, protocols, etc. used to enable the testing of the IT solution. The second (2) substep involves installing the development environment, which involves actually installing any equipment, software, tools, etc. set up in the preceding substep.

The third (3) substep involves coding system and batch jobs. This, in turn, may entail: (a) developing a configuration management process (e.g., for establishing procedures for scheduling and coordinating the coding activities of multiple individuals working on the project); (b) developing an error and exception handling code (e.g., for establishing basic protocols for handling errors and for defining exceptions to the basic protocols); (c) establishing provisions for performing batch jobs required by the IT solution, establishing Job Control Language (JCL) used in the IT solution, and establishing any scheduling-related or calendar-related functions performed by the IT solution; (d) building interfaces to other interrelated systems; (e) establishing conversion tools (e.g., for converting data from a previous IT product to a current IT product); (f) developing (e.g., writing) code for other related systems (e.g., systems that are interrelated with the current IT product); (g) developing code and/or processes for installing the IT product; (h) establishing monitoring procedures; and (i) generally compiling and constructing the IT product by integrating its various subsystems and components.

The fourth (4) substep involves establishing application testing. This substep may entail establishing tests for various units, modules and systems provided by the IT product. This substep may also entail establishing tests for other functional aspects of the IT product, and for interface features of the IT product.

The fifth (5) substep involves creating system documentation. This substep involves creating documentation with respect to: (a) support processes; (b) system manuals; (c) disaster recovery; and (d) training material and training schedules.

The sixth (6) substep involves establishing a rollout plan. This substep entails defining the procedures that will be used to introduce and install the new IT product (and potentially retire a pre-existing IT product). This substep may involve creating documentation of the rollout procedures.

The output of the fourth principal step includes one or more of the following deliverables: (1) the IT product itself (e.g., the system); (2) monitoring procedures; (3) code package; (4) test results; (5) configuration management; (6) installation/back-out documentation and procedures (a back-out procedure defines the steps that should be performed to take the IT product out of service (e.g., by removing code that has been installed); (7) training material; (8) systems manuals; (9) disaster recovery plan; (10) deployment documentation; (11) rollout and implementation plan; and (12) test scripts.

The fourth principal step terminates in approval step 118. This step assesses the viability of the project mainly based on the analysis performed in the fourth principal step. Exemplary authorizing agent(s) for the fourth principal step include one or more of: (1) business and technical subject matter experts; (2) service personnel; (3) developers; (4) database and infrastructure personnel, etc. If the authorizing agents approve the project, the process proceeds to the next principal step. If the authorizing agents do not approve the project, then the developers may revise or abandon the project.

E. Fifth Principal Step

The purpose of the fifth principal step is to test the developed solution. Another purpose of this principal step is to ensure that appropriate testing has been performed. Another purpose of this principal step is to establish agreement amongst project participants that the IT product is ready for deployment.

The responsible party for performing the fifth principal step may comprise an IT project manager or an appropriate business leader. The fifth principal step may receive inputs (e.g., information) from any appropriate area of IT and business (e.g., any appropriate IT or business-related subject matter expert).

The fifth principal step may specifically include six substeps. The first (1) substep involves configuring the test environment, which may include installing the user test environment and performing data conversion for user testing.

The second (2) substep involves configuring the production environment. This step pertains to setting up the software, tools, equipment, etc. to enable testing of the IT solution.

The third (3) substep involves performing testing. This may entail tests concerning different aspects of the IT product, including: (a) functional testing; (b) integration testing; (c) systems and data conversion testing; (d) stress testing; (e) acceptance testing (e.g., acceptance by users); (f) installation procedure testing; (g) load testing; (h) fail-over testing (e.g., pertaining to testing of the procedures for handling system failures, and in particular, procedures for switching from a failed system to an up-and-running system); (i) disaster recovery testing; and (j) security testing.

The fourth (4) substep entails performing user training. This substep may entail: (a) training a support team; (b) training an operations team; and (c) training users.

The fifth (5) substep involves developing support procedures and documentation. This substep entails: (a) creating maintenance and support manuals; (b) designing operating procedures; (c) creating support scripts; (d) establishing on-call procedures (e.g., establishing procedures for contacting support personnel, and for defining the responsibilities of the support personnel); and (e) establishing commitments (referred to as “warranties”) from the project management team regarding the nature of the services it will render with respect to the development and installation of the IT solution, the length of time that these services will be provided, and any conditions that will trigger the termination (or continuation) of these services.

The sixth (6) substep involves establishing disaster recovery procedures.

The output of the fifth principal step includes one or more of the following deliverables: (1) test results; (2) disaster recovery procedures; (3) support scripts and manuals; (4) warranty; (5) on-call procedures; (6) maintenance manuals; (7) help desk scripts; and (8) and disaster recovery (DR) procedures.

The fifth principal step terminates in approval step 122. This step assesses the viability of the project mainly based on the analysis performed in the fifth principal step. Exemplary authorizing agents for the fifth principal step include one or more of: (a) business and technical subject matter experts; (b) service IT solutions personnel (e.g., “service solutions IT team”) (c) developers, particularly with prior experience with the IT technology area; (d) database and infrastructure personnel; (e) quality assurance subject matter experts; (f) any appropriate personnel who oversee changes in the IT product's code (e.g., a “change management team”); and (g) the personnel who perform appropriate maintenance on the IT product. If the authorizing agents approve the project, the process proceeds to the next principal step. If the authorizing agents do not approve the project, then the developers may revise or abandon the project.

F. Sixth Principal Step

The purpose of the sixth principal step is to install the IT product in production and ensure that the IT product is stable and supportable. In other words, the purpose of the sixth principal step is to move the IT product from a development environment to a point where it is stable and running in a supported environment.

The responsible party for performing the sixth principal step may comprise an appropriate service project manager. The sixth principal step may receive inputs (e.g., information) from any appropriate area of IT and business (e.g., any appropriate IT or business-related subject matter experts).

The sixth principal step may specifically include seven substeps. The first (1) substep entails installing the production environment (which may include installing appropriate equipment, etc.)

The second (2) substep entails installing the IT product, which may include the following tasks: (a) installing the system; (b) converting data from one format to another, as necessary (e.g., from a format appropriate to a pre-existing system to a format appropriate to the new system); (c) conducting acceptance tests; (d) deploying the application; (e) tracking and mitigating defects; (f) performing cut-over (which involves breaking off use of the old system and initiating use of the new IT product).

The third (3) substep entails training support staff. This substep may also involve finalizing maintenance manuals and updating training materials.

The fourth (4) substep involves establishing on-call and escalation procedures. Escalation procedures define the actions that a user (or other interested party) should take in providing comments, airing complaints, making requests, etc., with respect to the IT solution. For instance, an exemplary procedure may require that a user initially seek resolution from a first party, and if unsuccessful, then seek resolution from a second party, etc. Further, different procedures may apply depending on whether the user takes action during the warranty period, as opposed to post-warranty period.

The fifth (5) substep involves executing retirement plans. A retirement plan ensures that a previous system or service that will be replaced by the current IT product is fully taken out of service. This may involve transferring information from the old IT system to the new system. This substep also ensures that the licenses applicable to the old system are terminated, so that the organization does not continue to pay license charges for technology it no longer uses.

The sixth (6) substep involves developing metrics (i.e., measurements) to assess the extent to which the progressing IT solution is meeting the Service Level Agreements (SLA's ) pertaining to the project.

The seventh (7) substep involves fulfilling the promises made by the project management team with respect to the delivery of the IT product (e.g., fulfilling the “warranty requirements” with respect to the IT product).

The eighth (8) substep involves notifying financial personnel within the organization of relevant information regarding the introduction of the new IT product.

The ninth (9) substep involves evaluating the IT solution. This substep may involve assessing whether or not the project management team has fulfilled its promises (i.e., “warranties”) regarding the IT solution).

The tenth (10) substep involves developing a support log.

The output of the sixth principal step includes one or more of the following deliverables: (1) escalation procedures;; (2) on-call procedures (warranty and post-warranty); (3) solution metrics; (4) project evaluation documentation; and (5) a support defects log.

The sixth principal step terminates in approval step 126. This step assesses the viability of the project mainly based on the analysis performed in the sixth principal step. Exemplary authorizing agent(s) for the sixth principal step include: (1) any appropriate business personnel; (2) service IT solutions team; (3) developers with prior experience in the IT product technology; (4) database and infrastructure personnel; and (5) the service area that will service the new IT product. If the authorizing agents approve the project, the process proceeds to the next principal step. If the authorizing agents do not approve the project, then the developers may revise or abandon the project.

G. Seventh Principal Step

The purpose of the seventh and last principal step is to terminate the project and perform all ancillary activities, such as project review. Another objective of the seventh principal step is to reach agreement as to whether the project has met its objectives.

The responsible party for performing the seventh principal step may comprise an appropriate project manager. The seventh principal step may receive inputs (e.g., information) from any appropriate area of IT and business (e.g., any appropriate IT or business-related subject matter expert).

The seventh principal step may specifically include seven substeps. The first (1) substep involves validating that the business requirements were met.

The second (2) substep involves identifying best practices and process improvements. Best practices refer to successful features of the current project that another project may want to adopt to improve its chances of success. Process improvements refer to features that could have been incorporated in the IT project to make it more successful.

The third (3) substep involves performing team evaluations. This substep also involves rewarding and recognizing the team for satisfactory or above-average performance.

The fourth (4) substep involves comparing the various aspects of the project plans with the actual realized project. This step may involve determining the extent to which the project deviated from schedules and budgets generated in previous principal steps. This step may also determine the extent to which the quality of the deliverables differ from what was planned.

The fifth (5) substep involves turning over project documentation to an appropriate project management archive within the organization. Project management teams handling future projects may access this archive and extract previous work product for application to their projects.

The sixth (6) substep involves closing out the cost center. The cost center refers to an area of an organization's general ledger where the costs and billing events pertaining to a particular project are recorded. The cost center is “closed out” by no longer permitting additional costs and billing events to be posted in that area.

The seventh (7) substep involves developing and setting up a plan for monitoring the IT product. This may involves monitoring the system, monitoring its benefits, and monitoring its capacity and performance. This substep may also entail establishing a plan for performing upgrades, backups, export/imports, etc.

The output of the seventh principal step includes one or more of the following deliverables: (1) explanation/documentation of variation of planned product to actual realized product (i.e., planned vs. actual analysis); (2) best practices sharing (e.g., identification and documentation of beneficial features of the project, so that subsequent project managers may learn and optionally adopt these beneficial features in future projects); (3) process improvement opportunities (e.g., identification of ways that the project can be (or could have been improved); (4) relevant project documentation; and (5) a benefits monitoring plan.

The last principal step terminates in approval step 130. This step assesses the viability of the project mainly based on the analysis performed in the seventh principal step. Exemplary authorizing agent(s) for the seventh principal step include: IT solutions delivery personnel and/or strategy and planning personnel. If the authorizing agents approve the project, the process terminates in step 132. If the authorizing agents do not approve the project, then the developers may revise the project.

In summary, the above-described process applies a highly structured approach to developing an IT project. This improves the efficiency of the development process and potentially reduces the chances of its failure. The use of approval procedures (i.e., approval “gates”) throughout the development process is particularly beneficial in identifying obstacles in the development process in a timely manner. In contrast, the prior unstructured approach typically identified these obstacles only when they were directly confronted in a late stage in the project's implementation.

2. Exemplary Implementation of Technique

The above-described process can be implemented in various ways. In general terms, the process is implemented by supplying appropriate responsible parties with information that describes the structured development process. The information may contain first data that identifies the principal steps, second data that identifies the substeps contained in each principal step, and third data describing the approval procedures. The developer accesses the information and then performs the principal steps, substeps, and approval procedures described therein.

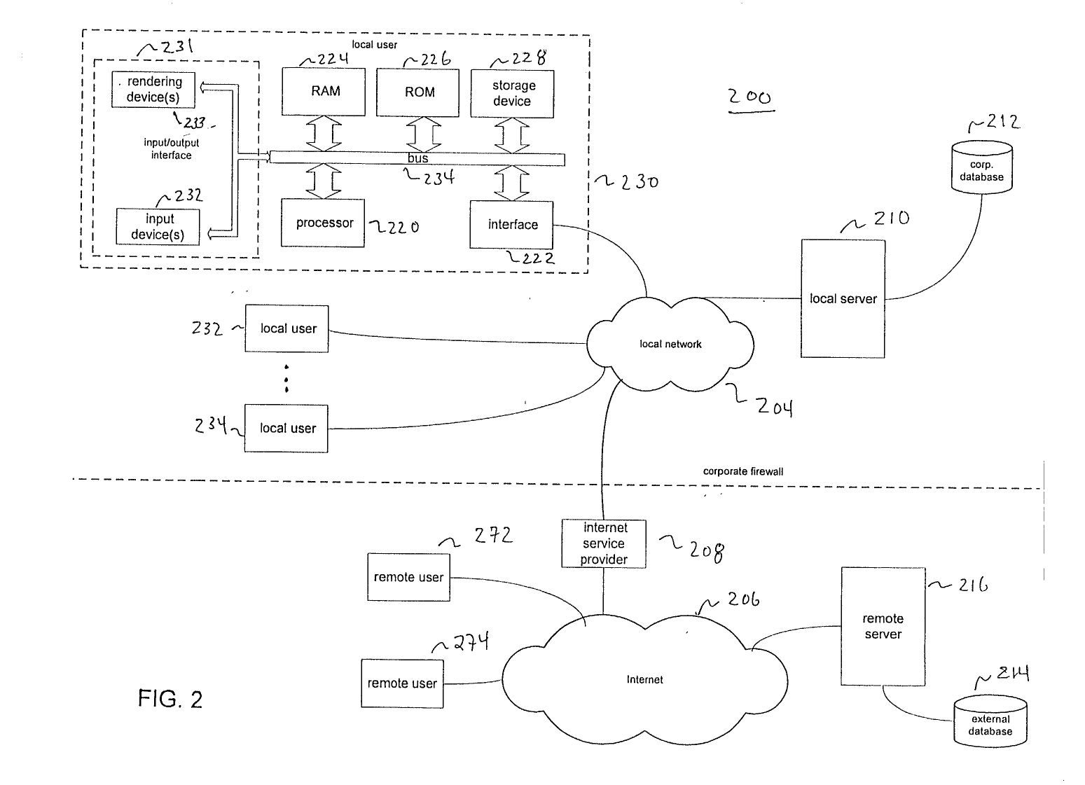

FIG. 2 describes one exemplary system 200 for implementing the process using a standalone computer and/or a group of computers connected to a network. The system 200 preferably includes at least one computer, such as computer 230. The computer 230 may include any general or special purpose computer. It includes conventional hardware components, including processor 220. The processor 220 is connected to random access memory (RAM) 224, read only memory (ROM) 226, and storage device 228 via bus 234. The computer receives input data from input device(s) 232, and supplies output to rendering device(s) 233, such as a display. In addition, or alternatively, the computer 230 can send its output to a printer (not shown). The input device(s) 232 and rendering device(s) 233 together define an interface unit 231.

Computer 230 may comprise any known type of computer. The computer may operate using any one of a variety of operating programs, such as the Microsoft Windows™ 98 program. The storage device 228 may include any storage, such as a hard drive, a CDROM, an optical disc, etc.

The computer 230 may comprise a standalone computer (i.e., a computer which does not communicate with a network). In other embodiments, the computer 230 is communicatively coupled using communication interface 222 to other computers (e.g., computer 232 and 234) via network 204. The network 204 can be formed as an intranet, a Personal Area Network (PAN), a Local Area Network (LAN), a Wide Area Network (WAN), a Metropolitan Area Network (MAN), or other type of network. The network 204 may alternatively use wireless technology to connect computers together. The computer 230 can also communicate with the Internet 206 via Internet Service Provider (ISP) 208, and any additional computers (e.g., computers 272 and 274) connected thereto. The networks may link users involved in the development process, such as members of the project management team, authorizing agents, etc.

The network can operate using any network-enabled code, such as Hyper Text Markup Language (HTML), Dynamic HTML, Extensible Markup Language (XML), Extensible Stylesheet Language (XSL), Document Style Semantics and Specification Language (DSSSL), Java™, etc.

The computer 230 can access one or more servers via the local network 204 and/or the Internet 206. For instance, the computer 230 can access a local host server 210 via local network 204, and can access remote server 216 via the local network 204 and the Internet 216. The local host server 210 is coupled to database 212, and the remote server 216 is connected to database 214.

The servers 210, 216 may comprise, for instance, workstations running any one of a variety of programs, such as Microsoft Windows™ NT™, Windows™ 2000, Unix, etc. The databases 212, 216 may be implemented as Oracle™ relational databases, or other data storage or query formats, platforms or resources.

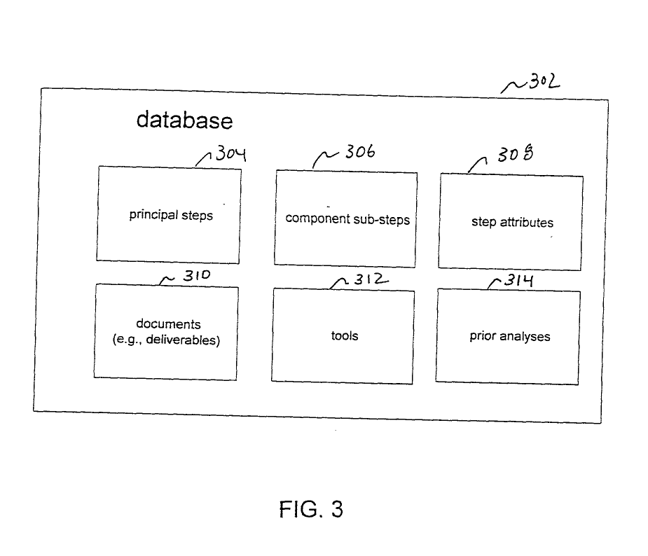

FIG. 3 shows database memory 302 containing information describing the process shown in FIG. 1. The information includes a principal steps file 304 that includes first data that identifies the principal steps in the process. The information further includes a component substeps file 306 that contains second data that identifies the substeps in each respective principal step. The information also includes an attributes file 308 that contains third data that identifies attributes of the steps of the process. For instance, this file may store information concerning the approval steps, such as the criteria used to evaluate the viability of the project, and an identification of the authorizing agent assigned to make the evaluation. The information also includes a documents file 310 that contains fourth data that identifies the deliverable documents associated with each principal step. The information further includes a tools file 312 that contains fifth data that identifies the tools that can be used to perform analysis associated with each principal step and substep. The tools file 312 may contain merely a link to another storage location that stores the actual tools, or may contain the software code to implement the tools. The tools may include a series of worksheets used to perform analysis associated with various principal steps and substeps. The tools may also include other software programs to perform financial analysis, to access information, or to communicate with other computers. Finally, the database memory 302 also includes a prior analyses file 314 that contains sixth data that identifies previous projects initiated by the organization. This file may particularly identify beneficial practices of the previous projects.

Each of the files 304, 306, 308, 310, 312 and 314 may form distinct units of information having separate addresses. Alternatively, these information files may represent merely separate information fields in a single addressable file. In either case, information stored in the five files is preferably cross-indexed to indicate how one field of information corresponds to other fields. For instance, the database preferably indicates the correspondence between the steps in files 304 and 306 and the documents in file 310 that are generated by each of the steps.

In a standalone computer application, the memory database 302 can be physically stored in one or more of RAM 224, ROM 226, and/or storage device 228. In a network application, the memory database 302 can be stored in server database 212 or database 214, or duplicated in the memories of each network computer (e.g., each of computers 230, 232, and 234). Further, the files within memory database 302 can be downloaded from one or more server databases to the local memory within computers 230, 232 or 234.

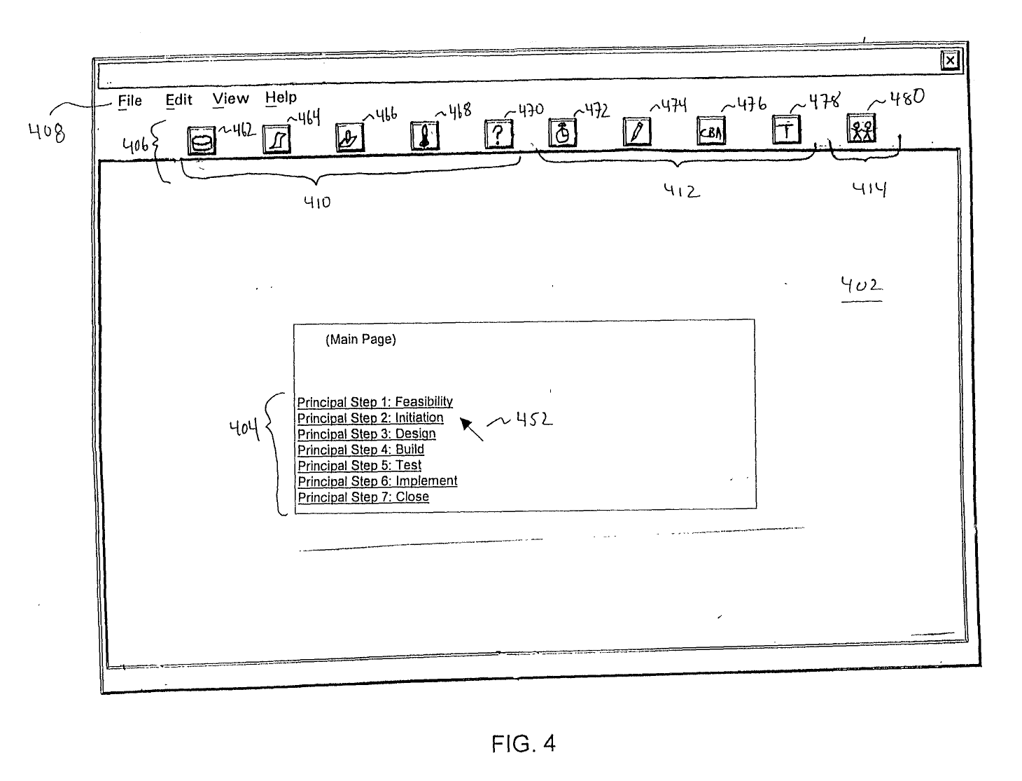

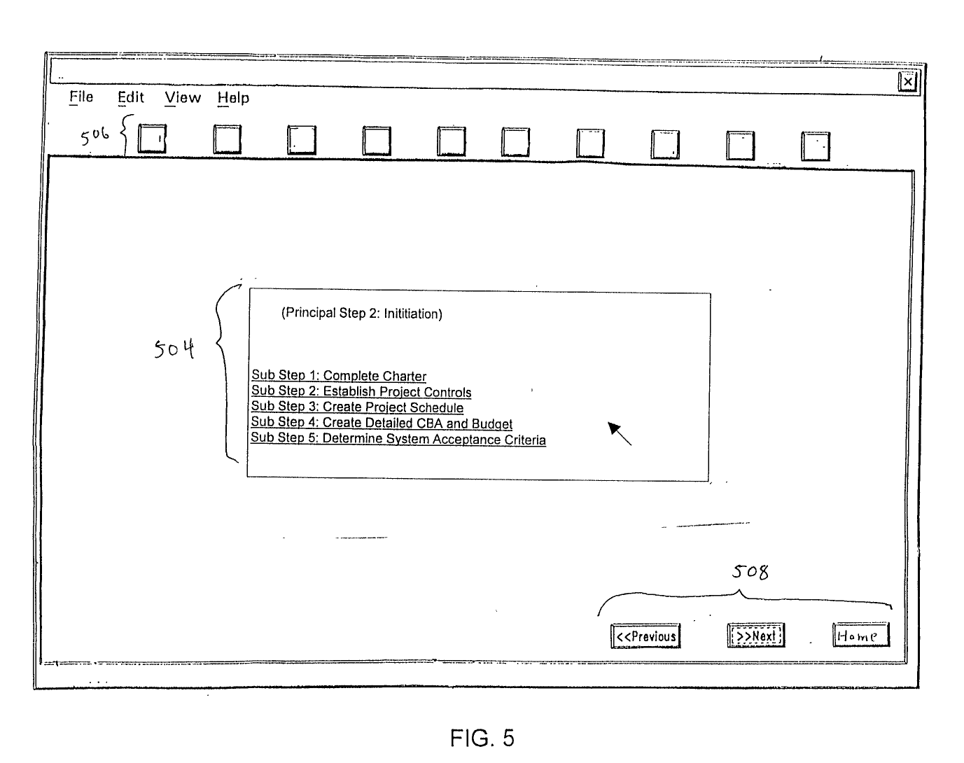

FIGS. 4-6 illustrate an exemplary computer interface allowing a user to access the process information and perform the steps in the process. FIG. 4 shows an exemplary main (initial) page or screen. The page may comprise conventional graphic interface components, such as a main display section 402, a tool bar 406, and a menu bar 408. The main display section 402 includes a listing 404 of the principal steps in the process, namely: a first principal step for assessing the feasibility of the project to determine whether to proceed with the project; a second principal step for performing initial project analysis to determine the project's functional requirements; a third principal step for designing the IT product; a fourth principal step for building the IT product; a fifth principal step for testing the IT product; a sixth principal step for implementing the IT product; and a seventh principal step for closing-out the IT project, including evaluating the project. Each principal step entry in the listing may include a stored link (e.g., a hypertext link) that associates each principal step to a respective sub-page that lists its component substeps. For instance, activating the link for the second principal step (initiating the project) will cause the display of a sub-page describing the second principal step. An example of this page is shown in FIG. 5 (to be discussed below). A link may be activated in a conventional manner, e.g., by clicking on the appropriate principal step text in FIG. 4 (e.g., note the cursor symbol 452 positioned on the second principal step).

The tool bar 406 contains an icon group 410 for use in accessing information relating to the process. Namely, a database icon 462 allows a user to query a database to retrieve a stored project file pertaining to one of a plurality of projects currently being carried out by an organization. The database icon 462 may also allow the user to access project files pertaining to projects that have been closed out (e.g., stored in file 314 of database 302). A deliverable icon 464 provides access to the deliverable documents generated by the process (for example, a charter document, risk form, etc.) Alternatively, this icon can access a database containing examples of prior completed deliverable documents. A “sign-off” icon 466 provides access to a master listing identifying those authorizing agents that are required to sign-off after the completion the principal steps. A help icon 470 provides access to information regarding the process. For instance, when the user sequentially activates the help icon 470 and the “initiation” principal step, the computer presents a detailed explanation of the tasks of this principal step. This step may also optionally provide access to a network (e.g., intranet or Internet) for retrieval of information regarding the process.

The tool bar 406 also contains an icon group 412 which provides access to various project management tools (that is, tools used in performing the project). For instance, a scheduling icon 472 provides a link to a software scheduling tool. The scheduling tool may allocate events in the process to timeslots, provide a detailed summary of the status of each step (including percent completed, duration, starting date, etc.), provide audible and/or visual reminders, etc. In one example, the Microsoft Project Plan™ program can be used. A worksheet access icon 474 provides a link to pre-stored worksheets. The worksheets serve as tools for analysis and may be tailored to a particular principal step or substep. Accordingly, these worksheets may be accessed and completed by the user at particular stages in the process. A CBA (cost-benefit analysis) icon 476 provides specific access to a cost-benefit analysis tool. This tool provides an evaluation of the costs and benefits of a particular project. A testing icon 478 provides access to one or more testing tools used to perform testing at various stages in project.

The tool bar 406 also may include an icon group 414 devoted to communications options. For instance, icon 480 can initiate a meeting between individuals involved in the process. For instance, a first project participant can use computer 230 (with reference to FIG. 1) to conduct a meeting with another project participant who is using computer 232 (with reference to FIG. 1) by activating the conferencing icon 480. More specifically, the computer system 200 can include hardware and software to provide video and/or audio conferencing features. For instance, using well known video conferencing technology, images of the remote meeting attendees can be projected on the computer screen in real time (or near real time). In yet another embodiment, the computer system may provide known remote control features. Such features allow a meeting leader to commandeer the control of the computer displays of the other attendees (the “passive attendees”) of the meeting. The actions performed by the meeting leader would then be duplicated on the screens of the passive attendees (such that, for instance, the same sequence of pages accessed by the meeting leader would be presented to the passive attendees).

FIG. 5, as mentioned above, identifies the substeps 504 in a principal step (e.g., in this case, the substeps in the second principal step). It is accessed by activating the link associated with the principal step “Initiation” listed in FIG. 4. The substeps include: substep 1 for completing project charter; substep 2 for establishing project controls; substep 3 for creating a project schedule; substep 4 for creating a detailed cost-benefit analysis and budget; and substep 5 for determining system acceptance criteria. Each of these substeps, in turn, comprises a link to further information regarding the activated substep. For instance, activating a substep link can access one or more worksheets that assist the user in performing the substep, or if so configured, may access detailed textual instructions regarding the substep.

The page shown in FIG. 5 also provides a group of tool icons 506. These tool icons can comprise the same tool icons identified in FIG. 4. Preferably, tool icons 506 also provide access to specific tools useful in performing the principal step being displayed. For example, activation of the deliverable icon in the context of FIG. 5 would preferably generate a display (not shown) that identifies only those deliverables appropriate for the second principal step. Further, activation of a cost-benefit analysis (CBA) icon in the context of FIG. 5 would preferably access the cost-benefit analysis tool(s) most appropriate for performing CBA analysis in the context the second principal step. The memory database (see FIG. 3) provides the relational links to provide this type of association between steps, deliverables, tools, and other information.

Finally, FIG. 5 includes well known navigation “buttons” 508 to access the previously accessed page (“previous”), the next screen in a stored series of screens (“next”), and the original screen shown in FIG. 4 (“home”).

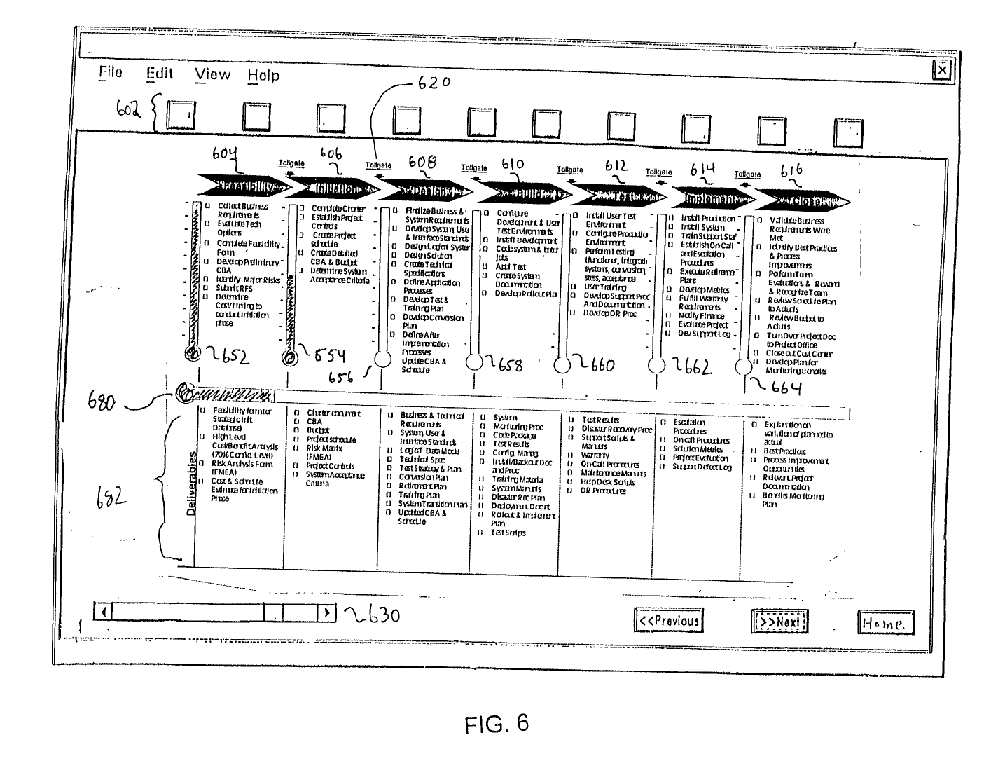

FIG. 6 provides a detailed process status screen (otherwise known as a “thermometer screen”), which can be accessed by activating the thermometer icon in a prior page (e.g., note thermometer icon 468 in FIG. 4). The arrow symbols and text legends (604, 606, 608, 610, 612, 614 and 616) represent principal steps in the process. Horizontal scroll bar 630 allows the user to adjust the horizontal position of the chart on the page (e.g., for those projects in which the chart does not fit on one page.

The substeps appear beneath their respective principal step legends (these substeps were discussed in connection with FIG. 1). Further, the chart presents thermometers that vertically extend beneath respective principal steps (e.g., note thermometers 652, 654, 656, 658, 660, 662 and 664). For example, thermometer 652 extends beneath the arrow symbol and text legend 604 designating the first principal step (“feasibility”). The thermometer can indicate the level of completion of a principal step by successively changing the color (or gray scale) of the thermometer to simulate the rising of the level of fluid in an actual thermometer. That is, the thermometer level is “low” when a principal step is initiated. The thermometer level is “high” when the task is almost completed.

The computer is also configured to present a horizontal thermometer 680. This thermometer can indicate the level of completion with respect to the overall process. That is, this thermometer can indicate how many of the principal steps have been completed by changing the color (or gray scale) of the thermometer to simulate the rising level of fluid in an actual thermometer. All level information presented in the horizontal and vertical thermometer charts can also, or in addition, be presented in numeric percentage format, or some alternative format.

In the specific example shown in FIG. 6, the project management team has fully completed the first principal step and has completed half of the substeps in the second principal step. This progress is represented by the respective levels shown on thermometers 652, 654 and 680.

The “tollgate” legends and accompanying arrow symbols (for example, “tollgate” 620) indicate the junctures at which approval procedures should be performed. These arrow symbols therefore designate gates (or checkpoints) because they prohibit further progress in the development process until the project meets the criteria specified in the approval procedures.

An authorized individual can update the thermometer chart by entering relevant information through a keyboard or other input device (e.g., via mouse) in a manner well known to those skilled in the art. For instance, in one implementation, the computer is configured to present the chart using the EXCEL™ software program, in which the screen defines a series of user entry fields. The user can enter symbols into the appropriate fields to designate progress through the process, such as by entering check marks in the thermometers via keyboard or mouse data entry. Alternatively, the computer can be configured to link information entered via another tool (such as a separate scheduling tool or sign-off worksheet) with progress data presented in the thermometer chart, such that the thermometer chart would automatically be updated upon data entry via the other scheduling tool.

The chart also presents a deliverables field 682 beneath the vertical thermometers. The deliverables field identifies the deliverables generated in each principal step. The deliverables were discussed in the context of FIG. 1. Optionally, the thermometer chart can also include another field (not shown) which identifies the authorizing agents that are assigned the role of validating the viability of the developing project.

Each of the fields in the thermometer chart may additionally include a link which provides access to additional information (e.g., by “clicking” on the field in the thermometer chart using a mouse, etc.). That is, the user can click on any principal step, substep, tollgate, deliverable, etc. to provide additional information regarding these topics (such as instructions, definitions, etc.). The chart may also be printed out and used as a hard-copy reference in performing the development process.

Finally, FIG. 6 provides a series of tool icons 602. These tool icons may comprise the same tools identified in FIG. 4. Alternatively, these icons may present an additional group of tools that are particularly adapted to interact with the thermometer presentation.

The interface may optionally include a number of other pages (not shown) that can be used in performing the steps of the project. For instance, the application may provide an authorization screen (not shown) for identifying the different authorizing agents that must “sign-off” on a project at the completion of each principal step. An agent may indicate his authorization by entering his name with a keyboard, mouse, etc., or by entering his digital signature. The computer system may additionally provide well-known security features to ensure that only authorized agents enter information through the authorization screen. For example, the computer system can compare an entered password or signature against a database of authorized passwords and signatures. Further, the system may prevent a user from accessing new worksheets (pertaining to new principal steps) if the appropriate authorizations have not been obtained in any approval stage.

Another worksheet page (not shown) may present tools for developing a schedule to perform the project. Still another worksheet page (not shown) may present tools for performing cost-benefit analysis. Yet another worksheet page (not shown) may present tools for monitoring the performance of the IT product. Another worksheet tool (not shown) may pertain to tools for testing the IT product.

In summary, the above-described technique provides a structured approach to the formulation, implementation, control, and improvement of an IT product. The technique may therefore contribute to reduced development costs, delays, and complications in the development process.

To facilitate explanation, the above discussion was framed in the context of an exemplary business environment characterized by defined exemplary business considerations. However, it should be noted that the principles described here apply to many different business environments having correspondingly different business considerations. For instance, different business environments may use a different set of authorizing agents than described above. Further, different business environments may attach different importance (or significance) to the agents' approval than described above. Accordingly, the above-described “preferred” modes of operation are exemplary and should not be construed as limitations on the invention as claimed.

More generally, while the foregoing description includes details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

What is claimed is:

1. A process for managing an information technology (IT) project to develop an information technology (IT) product, comprising the principal steps of:
assessing the feasibility of the project in a first principal step to determine whether to proceed with the project, and generating a first set of deliverables;
submitting the first deliverables to one or more authorizing agents in a first approval step to determine the viability of the project after the first principal step;
performing initial project analysis in a second principal step to determine the project's functional requirements, and generating a second set of deliverables;
submitting the second set of deliverables to one or more authorizing agents in a second approval step to determine the viability of the project after the second principal step;
designing the IT product in a third principal step, and generating a third set of deliverables;
submitting the third set of deliverables to one or more authorizing agents in a third approval step to determine the viability of the project after the third principal step;
building the IT product in a fourth principal step, and generating a fourth set of deliverables;
submitting the fourth set of deliverables to one or more authorizing agents in a fourth approval step to determine the viability of the project after the fourth principal step;
testing the IT product in a fifth principal step to determine the viability of the project, and generating a fifth set of deliverables;
submitting the fifth set of deliverables to one or more authorizing agents in a fifth approval step to determine the viability of the project after the fifth principal step;
implementing the IT product in a sixth principal step, and generating a sixth set of deliverables;
submitting the sixth set of deliverables to one or more authorizing agents in a sixth principal step to determine the viability of the project after the sixth principal step; and
terminating the IT project in a seventh principal step, including evaluating the project, and generating a seventh set of deliverables.

2. The process according to claim 1,
wherein the first set of deliverable includes one or more of the following deliverables: (a) a feasibility analysis; (b) a high level cost-benefit analysis; (c) a risk analysis; and (d) a cost and schedule estimate for the second principal step,
wherein the second set of deliverables includes one or more of the following deliverables: (a) the charter document; (b) a detailed cost-benefit analysis; (c) a project schedule; (d) a risk analysis matrix; (e) project controls documentation; (f) budget-related documentation; (g) system acceptance criteria; and (h) detailed requirements documentation,
wherein the third set of deliverables includes one or more of the following deliverables: (a) business and technical requirements; (b) system user and interface standards; (c) data model; (d) logical data model; (e) technical specification; (f) test strategy plan and scripts; (g) conversion plan; (h) retirement plan; (i) detailed training plan; (j) system transition plan; (k) updated cost benefit analysis and project schedule; and (l) IT product prototype,
wherein the fourth set of deliverables includes one or more of the following deliverables: (a) the IT product; (b) monitoring procedures; (c) code package; (d) test results; (e) configuration management; (f) installation/back-out documentation and procedures; (g) training material; (h) systems manuals; (i) disaster recovery plan; (j) deployment documentation; (k) rollout and implementation plans; and (l) test scripts,
wherein the fifth set of deliverables includes one or more of the following deliverables: (a) test results; (b) disaster recovery procedures; (c) support scripts and manuals; (d) warranty; (e) on-call procedures; (f) maintenance manuals; (g) help desk scripts; and (h) and disaster recovery procedures,
wherein the sixth set of deliverables includes one or more of the following deliverables: (a) escalation procedures pertaining to a hierarchical sequence of steps that may be used by the “recipients” of the IT product to demand that changes be made to the IT product; (b) on-call procedures; (c) solution metrics; (d) project evaluation documentation; and (e) a support defects log, and
wherein the seventh set of deliverables includes one or more of the following deliverables: (a) explanation/documentation of variation of planned product to actual realized product; (b) best practices sharing; (c) process improvement opportunities; (d) relevant project documentation; and (e) a benefits monitoring plan.

3. The process according to claim 1, wherein at least one of the principal steps includes plural substeps.

4. The process according to claim 1, further comprising the step of accessing and utilizing at least one tool to provide assistance in performing the project.

5. The process according to claim 1, further comprising the step of presenting information regarding the status of the project, including an indication of the level of completion of each of principal step.

6. A method for managing an information technology (IT) project to develop an information technology (IT) product, comprising the steps of:
providing information regarding a structured process for developing the IT product, the information including:
i) first data regarding principal steps of the structured process;
ii) second data regarding substeps included in each principal step, wherein each principal step includes at least one substep; and
iii) third data regarding approval procedures performed during the process for validating the viability of the project;
accessing the information; and
performing the principal steps, substeps, and approval procedures specified in the accessed information.

7. The method according to claim 6, wherein the step of performing comprises performing the following principal steps interspersed with the following approval steps:
assessing the feasibility of the project in a first principal step to determine whether to proceed with the project, and generating a first set of deliverables;
submitting the first deliverables to one or more authorizing agents in a first approval step to determine the viability of the project after the first principal step;
performing initial project analysis in a second principal step to determine the project's functional requirements, and generating a second set of deliverables;
submitting the second deliverables to one or more authorizing agents in a second approval step to determine the viability of the project after the second principal step;
designing the IT product in a third principal step, and generating a third set of deliverables;
submitting the third set of deliverables to one or more authorizing agents in a third approval step to determine the viability of the project after the third principal step;
building the IT product in a fourth principal step, and generating a fourth set of deliverables;
submitting the fourth set of deliverables to one or more authorizing agents in a fourth approval step to determine the viability of the project after the fourth principal step;
testing the IT product in a fifth principal step to determine the viability of the project, and generating a fifth set of deliverables;
submitting the fifth set of deliverables to one or more authorizing agents in a fifth approval step to determine the viability of the project after the fifth principal step;
implementing the IT product in a sixth principal step, and generating a sixth set of deliverables;
submitting the sixth set of deliverables to one or more authorizing agents in a sixth principal step to determine the viability of the project after the sixth principal step; and
terminating the IT project in a seventh principal step, including evaluating the project, and generating a seventh set of deliverables.

8. The method according to claim 6, wherein the information provided regarding the structured process additionally includes fourth data regarding output-deliverables produced by the structured process flow and the timing at which the output-deliverables should be generated.

9. The method according to claim 8, wherein the information provided regarding the structured process additionally includes fifth data regarding at least one tool that can be utilized to provide assistance in performing the project.

10. The method according to claim 9, wherein at least one tool includes at least one worksheet for use in performing at least one step in the structured process.

11. The method according to claim 6, wherein the step of providing information comprises providing a database containing first, second, and third files storing the first, second, and third data, respectively.

12. The method according to claim 11, wherein the step of accessing the information comprises utilizing a database access device to retrieve information stored in the database and presenting the information to a user.

13. The method according to claim 6, further comprising the step of presenting information regarding the status of the structured process to a user, including an indication of the level of completion of each of principal step.

14. A system for assisting a user in managing an information technology (IT) project to develop an information technology (IT) product, comprising:
a database providing information regarding a structured process for developing the project, the information including:
(i) a first file containing first data regarding principal steps used in the structured process;
ii) a second file containing second data regarding substeps included in each principal step, wherein each principal step includes at least one substep; and
iii) a third file containing third data regarding approval procedures performed during the process for validating the viability of the project; and
a database access device configured to access the database and allow the user to interact with the information, to thereby allow the user to perform the principal steps, substeps, and approval procedures specified in the information.

15. The system according to claim 14, wherein information provided in the first file identifies the following principal steps:
assessing the feasibility of the project in a first principal step to determine whether to proceed with the project, and generating a first set of deliverables;
performing initial project analysis in a second principal step to determine the project's functional requirements, and generating a second set of deliverables;
designing the IT product in a third principal step, and generating a third set of deliverables;
building the IT product in a fourth principal step, and generating a fourth set of deliverables;
testing the IT product in a fifth principal step to determine the viability of the project, and generating a fifth set of deliverables;
implementing the IT product in a sixth principal step, and generating a sixth set of deliverables; and
terminating the IT project in a seventh principal, including evaluating the project, and generating a seventh set of deliverables.

16. The system according to claim 15,
wherein the first set of deliverable includes one or more of the following deliverables: (a) a feasibility analysis; (b) a high level cost-benefit analysis; (c) a risk analysis; and (d) a cost and schedule estimate for the second principal step,
wherein the second set of deliverables includes one or more of the following deliverables: (a) the charter document; (b) a detailed cost-benefit analysis; (c) a project schedule; (d) a risk analysis matrix; (e) project controls documentation; (f) budget-related documentation; (g ) system acceptance criteria; and (h) detailed requirements documentation,
wherein the third set of deliverables includes one or more of the following deliverables: (a) business and technical requirements; (b) system user and interface standards; (c) data model; (d) logical data model; (e) technical specification; (f) test strategy plan and scripts; (g) conversion plan; (h) retirement plan; (i) detailed training plan; (j) system transition plan; (k) updated cost benefit analysis and project schedule; and (l) IT product prototype,
wherein the fourth set of deliverables includes one or more of the following deliverables: (a) the IT product; (b) monitoring procedures; (c) code package; (d) test results; (e) configuration management; (f) installation/back-out documentation and procedures; (g) training material; (h) systems manuals; (i) disaster recovery plan; (j) deployment documentation; (k) rollout and implementation plans; and (l) test scripts,
wherein the fifth set of deliverables includes one or more of the following deliverables: (a) test results; (b) disaster recovery procedures; (c) support scripts and manuals; (d) warranty; (e) on-call procedures; (f) maintenance manuals; (g) help desk scripts; and (h) and disaster recovery procedures,
wherein the sixth set of deliverables includes one or more of the following deliverables: (a) escalation procedures pertaining to a hierarchical sequence of steps that may be used by the “recipients” of the IT product to demand that changes be made to the IT product; (b) on-call procedures; (c) solution metrics; (d) project evaluation documentation; and (e) a support defects log, and
wherein the seventh set of deliverables includes one or more of the following deliverables: (a) explanation/documentation of variation of planned product to actual realized product; (b) best practices sharing; (c) process improvement opportunities; (d) relevant project documentation; and (e) a benefits monitoring plan.

17. The system according to claim 15, wherein information provided in the third file identifies the following approval steps:
submitting the first deliverables to one or more authorizing agents in a first approval step to determine the viability of the project after the first principal step;
submitting the second deliverables to one or more authorizing agents in a second approval step to determine the viability of the project after the second principal step;
submitting the third set of deliverables to one or more authorizing agents in a third approval step to determine the viability of the project after the third principal step;
submitting the fourth set of deliverables to one or more authorizing agents in a fourth approval step to determine the viability of the project after the fourth principal step;
submitting the fifth set of deliverables to one or more authorizing agents in a fifth approval step to determine the viability of the project after the fifth principal step; and
submitting the sixth set of deliverables to one or more authorizing agents in a sixth principal step to determine the viability of the project after the sixth principal step.

18. The system according to claim 14, wherein the information provided regarding the structured process additionally includes fourth data regarding deliverable-outputs produced by the project and the timing at which the deliverable-outputs should be generated.

19. The system according to claim 18, wherein the system additionally includes at least one tool that can be utilized to provide assistance in executing the structured process, and wherein the information provided regarding the structured process additionally includes fifth data regarding the identify of the at least one tool.

20. The system according to claim 19, wherein the at least one tool includes a worksheet for use in performing at least one step.

21. The system according to claim 14, wherein the database access device comprises an output device configured to present information regarding the status of the project, including an indication of the level of completion of each of principal step.

22. The system according to claim 14, wherein the database access device comprises a computer.

23. The system according to claim 14, further including:
at least one other database access device which is configured to access the database; and
a network configured to communicatively connect the database access devices together.

24. A system for assisting a user in managing an information technology (IT) project to develop an information technology (IT) product, comprising:
a database providing information regarding a structured process for developing the project, the structured process including a plurality of principal steps, each having at least one substep;
a database access device configured to access the database and allow the user to interact with the information, to thereby perform the principal steps and substeps;
wherein the database access device includes an output device configured to present information regarding the status of the structured process, including an indication of the level of completion of each principal step;
wherein information regarding the structure process provided in the database identifies the following principal steps:
assessing the feasibility of the project in a first principal step to determine whether to proceed with the project, and generating a first set of deliverables;
performing initial project analysis in a second principal step to determine the project's functional requirements, and generating a second set of deliverables;
designing the IT product in a third principal step, and generating a third set of deliverables;
building the IT product in a fourth principal step, and generating a fifth set of deliverables;
testing the IT product in a fifth principal step to determine the viability of the project, and generating a fifth set of deliverables;
implementing the IT product in a sixth principal step, and generating a sixth set of deliverables; and
terminating the IT project, including evaluating the project, and generating a seventh set of deliverables.

25. The system according claim 24, wherein the indication of the level of completion comprises a thermometer-type display for each principal step.
